(19) United States
(12) Patent Application Publication
(10) Pub. No.: US 2015/0218867 A1
(43) Pub. Date: Aug. 6, 2015

(54) DOOR CLOSER

(71) Applicant: RYOBI LTD., Hiroshima (JP)

(72) Inventor: Kohji Ishida, Fuchu-shi (JP)

(21) Appl. No.: 14/430,849

(22) PCT Filed: May 21, 2013
(86) PCT No.: PCT/JP2013/064037

§ 371 Date: Mar. 24, 2015

(30) Foreign Application Priority Data
Sep. 28, 2012 (JP) 2012-218351

(51) Int. Cl. E05F 3/10

(52) U.S. Cl. CPC E05F 3/10

(57) ABSTRACT

The invention is to provide a door closer capable of easily adjusting a flow rate of working oil while utilising a cam type advantage of having high torque just before a door is fully closed. A door closer includes a main shaft (3) rotated with opening and closing operation of a door, a main spring (16, 17) for producing a closing force, and a buffer piston (10) for running working oil into a flow control path (9) in order to buffer door closing operation, wherein the main shaft (3) is provided with a cam (12) for elastically deforming the main spring (16, 17) at the time of door opening operation and being subjected to the closing force of the main spring (16, 17) at the time of door closing operation, and a rack (21) as a buffer driving part for moving the buffer piston (10) according to opening and closing operation of the door provided to the main shaft separately from the cam. Specifically, a slide-type door closer configured such that a distal end of an arm, which is rotated integrally with the main shaft (3), is guided along a rail and is slid.

### TECHNICAL FIELD

The present invention relates to a door closer.

### BACKGROUND ART

A door closer configured such that a main shaft is provided with a cam for compressing a main spring for producing a dosing force at the time of door opening operation and also door closing operation is buffered by running working oil into a flow control path by moving a buffer piston using the cam at the time of door closing operation is proposed as described in PTL 1. A configuration of such a cam type has an advantage of having high torque just before a door is fully closed. However, there is a problem of being difficult to adjust an adjusting valve for controlling a flow rate of the working oil passing through the flow control path since the amount of movement of the buffer piston is small at the time of door closing operation. Also, it is necessary to decrease a gap of the adjusting valve since the flow rate itself of the working oil passing through the flow control path is small, but there is a problem of tending to clog its gap with dust, and as a result of being clogged with dust, there is a problem of causing variations in speed of the door closing operation.

### Citation List

### Patent Literature

PTL 1: JP-B-H05-20547

### SUMMARY OF INVENTION

### Technical Problem

Hence, the invention has been implemented in view of the conventional problems described above, and a problem of (be invention is to provide a door closer capable of easily adjusting a flow rate of working oil while utilizing a cam type advantage of having high torque just before a door is fully closed.

### Solution to Problem

The invention has been made to solve the above-described problem, and a door closer according to the invention comprises: a main shaft rotated with opening and closing operation of a door; a main spring for producing a closing force; and a buffer piston for running working oil into a flow control path in order to buffer a door closing operation, wherein the main shaft is provided with: a cam for elastically deforming the main spring at the time of door opening operation and being subjected to the closing force of the main spring at the time of the door closing operation; and a buffer driving part for moving the boiler piston according to opening and closing operation of the door, the buffer driving part being provided to the main shall separately from the cam.

In the door closer having the above-described configuration, the main shaft is provided with the cam for elastically deforming the main spring. That is, since the configuration of a cam type is adopted, high torque can be generated in the main shaft just before a door is fully closed, the door can surely be closed to a fully closed state. Accordingly, the door closer is particularly useful in, for example, a room with high airtightness. Since the main shaft is also provided with the buffer driving part for moving the buffer piston separately from the cam, the amount of movement of the buffer piston can easily be set greatly without restrictions of the cam. Accordingly, at the time of door closing operation, the boiler piston can be moved greatly to increase a flow rate of the working oil passing through the flow control path.

Incidentally, the door closer includes a link type and a slide type. The link type is a type in which two link arms are interposed between a main shaft and a bracket, and tire slide type is a type having only one arm rather than the two link arms. That is, in the slide-type door closer, the proximal end of the arm is fastened to a main shaft in a state incapable of relative rotation, and the arm and the main shaft are integrally rotated, and the distal end of the arm is guided by a rail fixed to, for example, a door frame and is slid along the rail in a horizontal direction. The slide-type door closer has an advantage of having beauty better than that of the link type. The invention can be applied to both of the link-type door closer and the slide-type door closer, and in the slide-type door closer, it is often relatively difficult to generate high torque just before the door is folly closed as compared with the door closer of the link type. Accordingly, the invention is particularly suitable for the slide-type door closer, and high torque can easily be generated just before the door is frilly closed even for the slide-type door closer.

Preferably, a body housing may comprise two chambers, one of which is provided with a main spring and the other of which is provided with a buffer piston. By forming the two chambers, the main spring and the buffer piston can be arranged respectively individually. Since the main spring and the buffer piston are arranged in one chamber and the side of the buffer piston is also provided with a separate spring in a configuration described in the PTI 1, this configuration has problems that the structure is complicated and also as a result of interference between the main spring and the separate spring, it is difficult to smoothly move the buffer piston by a cam and also a closing force tends to become unstable. On the other hand, the body housing is provided with the two chambers, and the main spring and the buffer piston are respectively arranged in their chambers and thereby, interference between operation of the main spring and operation of the buffer piston can surely be prevented, and the closing force can accurately be produced to smoothly run the working oil into the flow control path.

Further, it is preferable such that a shaft line direction of the main shaft may be a vertical direction, and the door closer may be provided with a buffer driving part displaced from the cam in the vertical direction, and the body housing may comprise an upper chamber and a lower chamber having working oil therein, the main spring is arranged in one of the upper chamber and the lower chamber, and the buffer piston is arranged in the other of the upper chamber and the lower chamber. The cam and the buffer driving part are arranged with the cam displaced from the buffer driving part in the vertical direction which is the shaft line direction of the main shaft and thereby, arrangement of the cam and the buffer driving part is facilitated and also, the two chambers are the upper chamber and the lower chamber, with the result that the dimension of the apparatus in the front-back direction can particularly be decreased compactly.

Still further, it may be preferable such that the door closer may comprise a pinion gear as the buffer driving part, wherein a rack configured to helically engage the pinion gear may be formed in the buffer piston, wherein an elastic deformation direction of the main spring may be mutually parallel to a movement direction of the buffer piston, wherein the upper chamber and the lower chamber may be arranged adjacently in the vertical direction, and wherein the chamber may comprise an extension part in at least one of; a side opposite to a side in which the main spring is arranged with respect to the cam; and a further door opening side that is further beyond a position that is a maximum moving position of the butler piston at the door opening side. By adopting a rack and pinion mechanism, the buffer piston can be moved easily surely, and can easily have a long movement stroke. The elastic deformation direction of the main spring is mutually parallel to the movement direction of the buffer piston, and the upper chamber and the lower chamber are vertically arranged and thereby; the dimensions of the body housing in the vertical direction as well as the front-back direction can be decreased. The extension part of the chamber is formed in the side opposite to the side in which the main spring is arranged with respect to the cam, or in the side further beyond the position that is the maximum moving position of the buffer piston at the door opening side and thereby, the working oil can also be put into the extension part of the chamber. Accordingly, capacity of the working oil can be increased, with the result that deterioration of the working oil can be reduced.

Particularly in that case, it is preferable such that the extension part of the chamber may be formed in the further door opening side that is further beyond the position that is the maximum moving position of the buffer piston at the door opening side, and the extension part may be provided with an auxiliary spring that is not elastically deformed at the time when the door is opened at less than a predetermined angle and is elastically deformed at the time when the door is opened at the predetermined angle or more. Since a configuration using the cam has a weak force necessary to open the door soon after the start of door opening operation this configuration has an advantage capable of easily opening the door by a weak force. However, a closing force transmitted from the main spring to the cam becomes weak at the time when door closing operation is started from a folly opened state. Accordingly, the auxiliary spring compressed or expanded at the time when the door is opened at the predetermined angle or more is arranged in the extension part arid thereby, the auxiliary spring can compensate for the closing force at the time when the door closing operation is started, and the door closing operation is started surely. In a state in which the door is fully closed, the auxiliary spring may have a natural length, or a state compressed or expanded already by a predetermined amount.

Further, it may be preferable such that the main shaft may have a divided structure in the vertical direction, the cam may be formed integrally to one of an upper side shaft part and a lower side shaft part, both of which configures the main shaft, and a pinion gear as the buffer driving part is formed integrally to the other of the upper side shaft part and the lower side shaft part, and a rack configured to helically engage the pinion gear may be formed in the buffer piston. By adopting a rack and pinion mechanism like the configuration described above, the buffer piston can be moved easily surely, and can easily have a long movement stroke. The main shaft has the vertical division configuration, and the cam is formed integrally to one of the upper side shaft part and the lower side shaft part, and the pinion gear is formed integrally to the other shaft part so as to form one member together with the main shaft rather than a member separate from the main shaft and thereby, the cam and the pinion gear can be formed with higher accuracy and more easily than the ease of the configuration in which the cam and the pinion gear are separate from the main shaft.

As one preferable aspect, the main spring is arranged in the upper chamber and the buffer piston is arranged in the lower chamber, and the upper chamber communicates with the lower chamber through a communication hole. A small amount of air is mixed into the working oil in order to absorb expansion of the working oil due to a rise in temperature, but noise is generated at the time when its air passes through the flow control path. Hence, by arranging the buffer piston in the lower chamber, the air accumulates in the upper chamber and becomes resistant to entering the flow control path, and generation of the abnormal noise caused by the air can be reduced.

### Advantageous Effects of Invention

Since the door closer according to the invention as described above is configured such that the main shaft is provided with the buffer driving part separately from the cam and the buffer piston is moved by the buffer driving part, the buffet piston can be moved greatly and a flow rate of the working oil can easily be adjusted and moreover, the main spring is elastically deformed by the cam, with the result that high torque can be generated just before the door is fully closed.

### BRIEF DESCRIPTION OF DRAWINGS

FIG. 1 is a longitudinal sectional view showing a door closer in one embodiment of the invention.

FIG. 2 is a sectional view taken on line A-A of FIG. 1.

FIG. 3 is a longitudinal sectional view showing a state in which a door is opened 180° in a use state of the door closer.

FIG. 4 is a sectional view corresponding to FIG. 2, showing a state in which the door is opened 180° in the use state of the door closer.

FIG. 5 is a longitudinal sectional view showing a door closer in another embodiment of the invention.

FIG. 6 is a longitudinal sectional view showing a door closer in a further embodiment of the invention.

FIG. 7 is a longitudinal sectional view showing a door closer in a further embodiment of the invention.

FIG. 8 is a longitudinal sectional view showing a door closer in a further embodiment of the invention.

FIG. 9 is a longitudinal sectional view showing a main part of a door closer in a farther embodiment of the invention.

### DESCRIPTION OF EMBODIMENTS

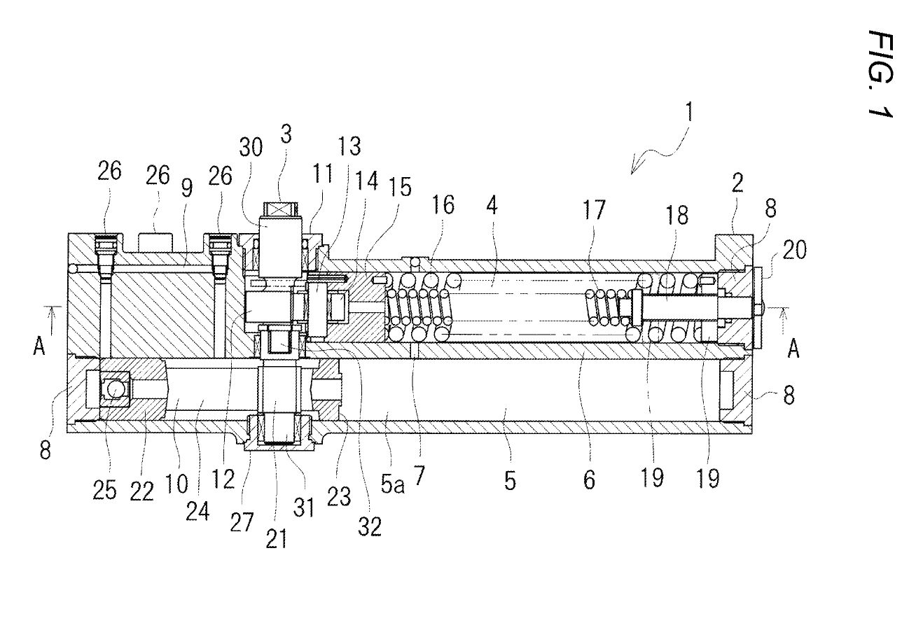

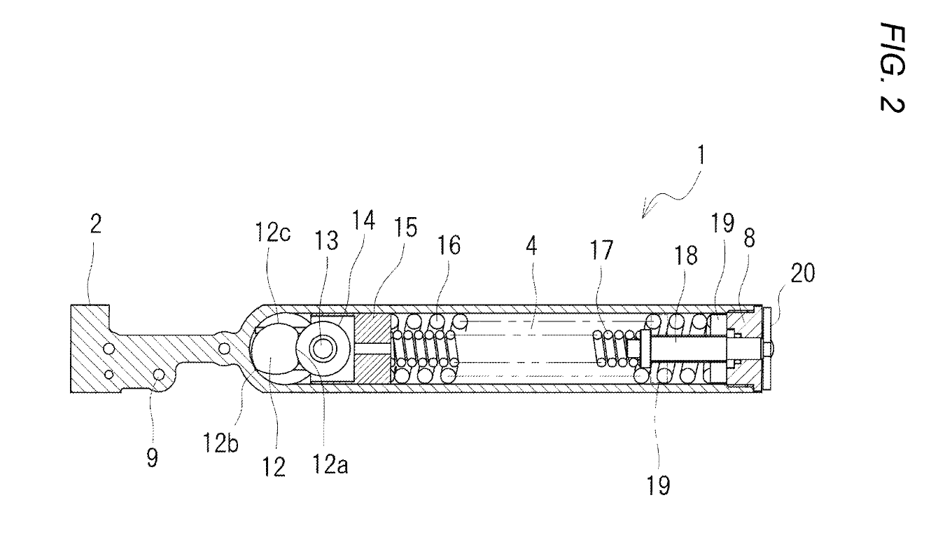

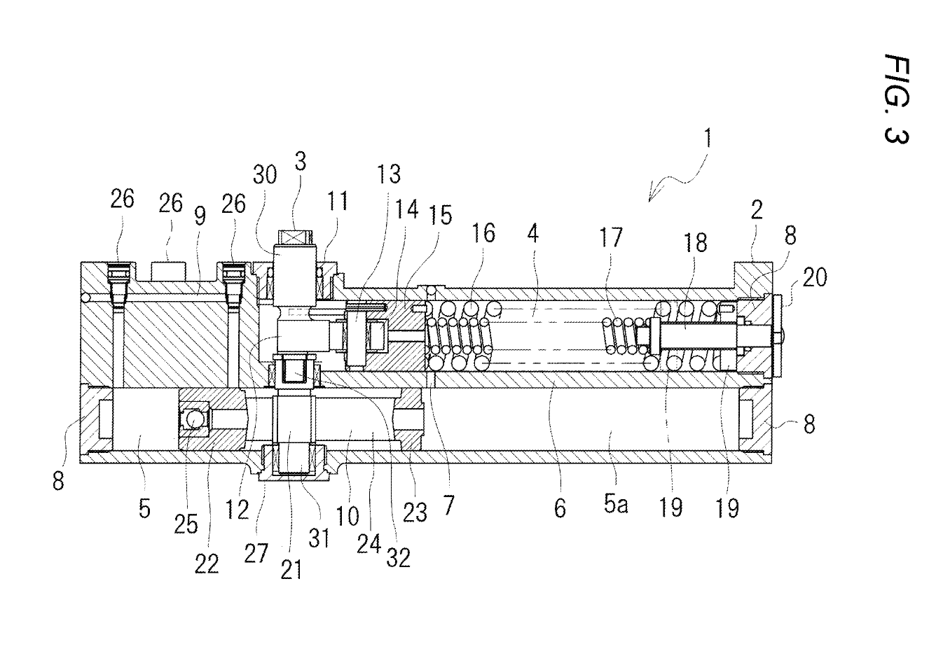

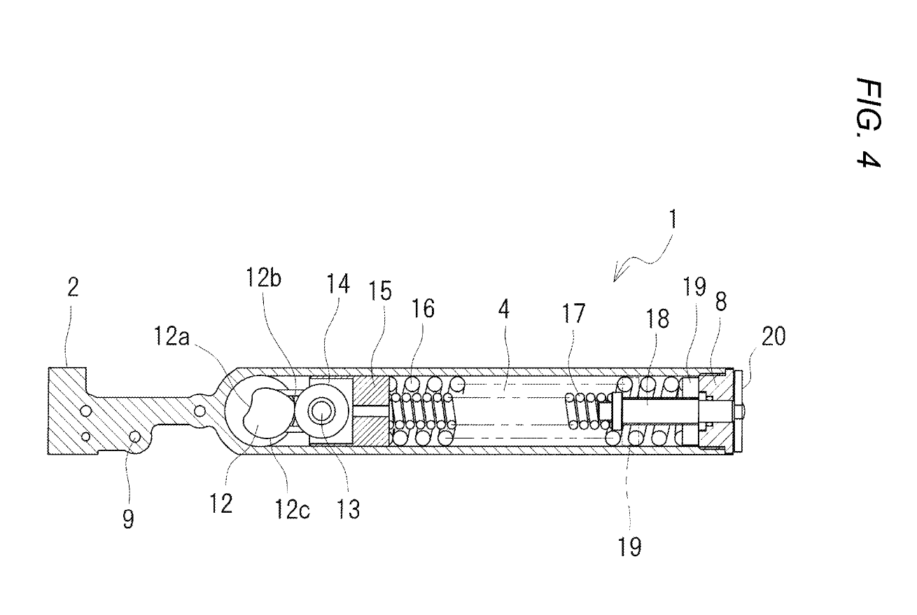

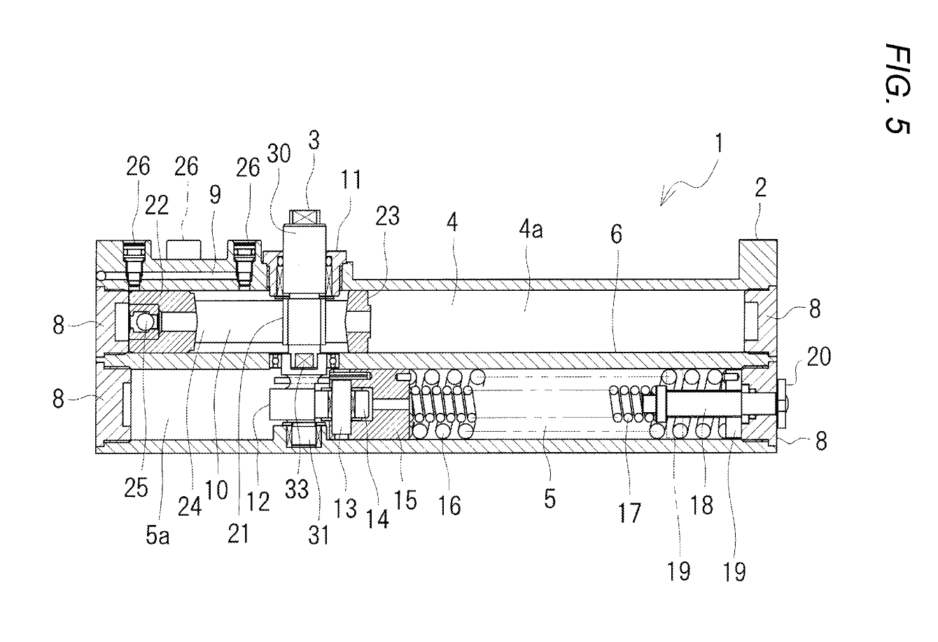

A door closer according to one embodiment of the invention will hereinafter be described with reference to FIGS. 3 to 4. The door closer in the present embodiment includes a door closer body 1 as shown in FIGS. 1 to 4. FIGS. 1 and 2 show a state in which a door is fully closed, and FIGS. 3 and 4 show a state in which the door is fully opened. All of FIGS. 5 to 9 described below show a state in which the door is fully closed.

The door closer body 1 includes a body housing 2, and a main shaft 3 pivoted on the body housing 2 and rotated around a shaft line in a vertical direction. The proximal end of an arm (not shown) is attached to the main shaft 3 in a state incapable of relative rotation. The door closer body 1 is attached to a door frame or a door turned around the shaft line in the vertical direction and, for example, in the case of being attached to the door, a rail (not shown) extending in a horizontal direction is attached to the door frame and the distal end of the arm is engaged with the rail. When the door is turned, the arm and the main shaft 3 are integrally rotated according to opening and closing operation of the door and the distal end of the arm is guided by the rail and also is slid in the horizontal direction.

The body housing 2 has a generally landscape rectangular parallelepiped shape long in the horizontal direction (transverse direction), and has a shape with a long dimension in the vertical direction (longitudinal direction) with respect to a dimension in a front-back direction (depth direction of paper). In FIG. 1, the observers' right side is set on one end side in the transverse direction and the observers' left side is set on the other end side m the transverse direction and in the following explanation, one end side and the other end side are simply called the right side and the left side. The turning center of the door is positioned on the observers' left side with respect to the door closer body 1.

Two vertical chambers extending in the transverse direction are formed in the body housing 2. The upper chamber 4 and the lower chamber 5 are formed with the chambers arranged vertically mutually, and shaft line directions of the chambers are mutually parallel in the transverse direction, and both of the chambers are filled with working oil. The upper chamber 4 and the lower chamber 5 form respectively independent chambers by being partitioned with a partition wall 6 located between both of the chambers, but a communication through hole 7 is formed in the partition wall 6 and the upper chamber 4 mutually communicates with the lower chamber 5 by the communication hole 7. While the lower chamber 5 has a length near to the whole length of the body housing 2 in the transverse direction, the upper chamber 4 has a length shorter than that of the lower chamber 5. The lower chamber 5 is formed by forming a transversely through hole in the body housing 2 and also respectively sealing openings of both ends of its through hole with transverse caps 8. On the other hand, the upper chamber 4 is formed with the upper chamber 4 biased to the right side with respect to the lower chamber 5. That is, the upper chamber 4 is formed by forming a transverse hole, without penetration, with only the right end opened in the body housing 2 and sealing an opening of the right end of its transverse hole with a transverse cap 8. A main spring for producing a closing force by which a door is closed is received in the upper chamber 4, and a buffer piston 10 for running working oil into a flow control path 9 in order to buffer door closing operation is received in the lower chamber 5.

The main shaft 3 is arranged so as to extend through the upper chamber 4 and the lower chamber 5. The main shaft 3 is arranged with the main shaft 3 biased to the left side beyond the transverse center of the body housing 2, and is positioned in the vicinity of the left end of the upper chamber 4. That is, the main shaft 3 is arranged with the main shaft 3 offset to the turning center side of the door and accordingly, the dimension from the main shaft 3 to the right end of the door closer body 1 becomes longer than the dimension from the main shaft 3 to the left end of the door closer body 1. The main shaft 3 is rotatably supported in an upper cap 11 and a lower cap 27 attached to an upper surface and a lower surface of the body housing 2 through bearings and also, is rotatably supported in the partition wall 6 through a bearing. While the lower end of the main shaft 3 is not projected from the lower cap 27, the upper end of the main shaft 3 is projected from the upper cap 11 upwardly by a predetermined length, and the proximal end of the arm (not shown) is attached to the upward projected part of the main shaft 3 in a state incapable of relative rotation.

An upper part of the main shaft 3 is provided with a heart-shaped cam 12. The cam 12 is processed and formed integrally to the main shaft 3 so as to configure one member rather than a configuration of a member separate from the main shaft 3. The earn 12 is positioned in the height corresponding to the upper chamber 4, and is configured so as to compress the main spring at the time of door opening operation and be subjected to a closing force by the elastic restoring force from the main spring at the time of door closing operation. The cam 12 is a plate earn using its peripheral surface as a cam surface, and a predetermined angle domain in the whole periphery is set in a use section in opening and closing operation of the door, and a one-sided angle domain from a recess 12a to the top 12b is a use section 12c.

A roller 14 as a cam follower supported in a vertical support shaft 13 abuts on the cam 12. The support shaft 13 of the roller 14 is attached to a spring support 15 movable inside the upper chamber 4 along the transverse direction which is the shaft line direction of the upper chamber 4, and the spring support 15 presses and compresses the main spring located in the right side of the spring support 15 at the time of door opening operation. A through hole extending in the transverse direction is formed in the spring support 15, and the working oil can pass through the through hole.

The main spring includes two large and small coil springs 16, 17. The large-diameter coil spring 16 and the small-diameter coil spring 17 are arranged mutually coaxially. That is, the small-diameter coil spring 17 is inserted inside the large-diameter coil spring 16. An adjusting shaft 18 transversely extends through the center of the transverse cap 8 of the upper chamber 4 and is projected inside the upper chamber 4 by a predetermined length, and a male screw part is formed on its projected portion. A spring force adjusting nut 19 is screwed on the male screw part of the adjusting shaft 18. The adjusting shaft 18 is supported in the transverse cap 8 rotatably around the shaft line of the transverse cap 8, and an adjusting gear 20 is attached to the right end (end of the outside) of the adjusting shaft 18 slightly projected to the outside of the body housing 2. By rotating the adjusting gear 20 by an adjuster (not shown), the adjusting shaft 18 can be rotated to move the spring force adjusting nut 19 in the transverse direction. The large-diameter coil spring 16 is interposed between the spring force adjusting nut 19 and the spring support 15 and accordingly, its spring force can be adjusted. On the other hand, the small-diameter coil spring 17 is interposed between the spring support 15 and the left end (end of the inside) of the adjusting shaft 18 and accordingly, its spring force cannot be adjusted.

As shown in FIG. 2, at the time of full closing, the roller 14 is in a state engaging with the recess 12a of the cam 12, and when the door is opened from this state, the cam 12 is rotated clockwise in FIG. 2. The cam 12 has an angle of more than 180° (as an example, an angle of about 225°) clockwise from the recess 12a to the top 12b of the cam 12, and as shown in FIG. 4, the roller 14 does not reach the top 12b of the cam 12 even in a state in which the door is opened up to 180°. Thus, the cam 12 has an asymmetric shape in which a length of the use section 12c in opening and closing operation of the door in the whole periphery becomes longer than a length of an unused section having the residual peripheral length.

A pinion gear 21 is formed integrally to a lower portion of the main shaft 3. The pinion gear 21 is also processed and formed integrally to the main shaft 3 so as to configure one member rather than a configuration of a member separate from the main shaft 3. The pinion gear 21 is in the lower side from the cam 12 by a predetermined height and is positioned in the height corresponding to the lower chamber 5, and configures a buffer driving part for transversely moving the buffer piston 10 according to opening and closing operation of the door. The buffer piston 10 respectively has head parts 22, 23 sliding on a wall surface of the lower chamber 5 in both ends of the buffer piston 10, and a rack 24 is formed between both of the head parts 22, 23, and the pinion gear 21 of the main shaft 3 helically screws the rack 24. In both of the head parts 22, 23, through holes are respectively formed in the center and the through hole of the left head part 22 is provided with a check valve 25. At the time of door opening operation, the buffer piston 10 is moved to the right side and at that time, a ball which is a valve element of the check valve 25 is moved to the left side to open the valve, and working oil can pass through the through hole. On the other hand, at the time of door closing operation, the buffer piston 10 is moved to the left side and at that time, the ball of the check valve 25 is pressed to the right side by oil pressure to close the through hole, and the working oil cannot pass through the through hole. The working oil pressed to the left side by the buffer piston 10 at the time of door closing operation is pushed into the flow control path 9 which is a bypass, and is moved in a region of the right side beyond the left head part 22 through the flow control path 9. The flow control path 9 is provided with an adjusting valve 26 for controlling a flow rate of the working oil passing through the flow control path 9. The plural (concretely, three) adjusting valves 26 are arranged.

Since the embodiment is described by taking the case of a door closer of the so-called concealed type in which the door closer body 1 is arranged inside the door as an example, all the plural adjusting valves 26 are arranged on an upper surface of the body housing 2 and the flow rate can be adjusted from the upper side. Since the buffer piston 10 is arranged in the lower chamber 5, the flow control path 9 is formed from a wall surface of the lower chamber 5 to the vicinity of the upper surface of the body housing 2. In the body housing 2, the upper chamber 4 is not formed in the left side of the cam 12. The flow control path 9 is formed in its left portion in which the upper chamber 4 is not formed in the upper portion of the body housing 2. In other words, around the main shaft 3, the main spring is arranged in the right side and the flow control path 9 is formed in the fell side opposite to the right side.

In the case of using the door closer of the embodiment, the door can be opened up to 180°, and FIGS. 3 and 4 show a fully opened state in which the door is opened 180°. In the fully opened state of the door, the buffer piston 10 is in a state moved to the right side at a maximum, and in its state, the buffer piston 10 does not abut on the right transverse cap 8 of the lower chamber 5 and is separated from the right transverse cap 8. That is, the lower chamber 5 is formed long by a predetermined length with an allowance provided in the right side (door opening side) further beyond a place in which the boiler piston 10 is moved to the right side (door opening side) at a maximum, and this allowance length, namely, the portion between the buffer piston 10 and the right transverse cap 8 in FIGS. 3 and 4 forms an extension part 5a of the lower chamber 5. The length of this extension part 5a is longer than the stroke of the buffer piston 10, and is about several times that of the stroke.

With opening and closing operation of the door, the main shaft 3 is rotated and its rotation moves both of the spring support 15 and the buffer piston 10, and the amount of movement of the buffer piston 10 is larger than that of the spring support 15. As shown in FIGS. 3 and 4, in a state in which the spring support 15 and the buffer piston 10 is moved to the right side at a maximum, a right end face of the spring support 15 and a right end face of the buffer piston 10 are in substantially the same position in the transverse direction. The communication hole 7 is formed is the right side beyond its position so as not to be closed by the spring support 15 and the buffer piston 10.

The main shaft 3 has a vertical two-division structure in which two vertical shaft parts are integrally joined mutually vertically. That is, the main shaft 3 includes an upper side shaft part 30 and a lower side shaft part 31, and the lower end of the upper side shaft part 30 is joined to the upper end of the lower side shaft part 31 in a state incapable of relative rotation mutually. There are various joining structures and in the embodiment, the shaft parts are joined by vertical serrations 32. The cam 12 is formed integrally to the upper side shaft part 30, and the pinion gear 21 is formed integrally to the lower side shaft part 31. The upper side shaft part 30 is inserted from an upper surface of the body housing 2, and the lower side shaft part 31 is inserted from a lower surface of the body housing 2, and the upper side shaft part 30 and the lower side shaft part 31 are mutually joined in a position of the partition wall 6 by the serrations 32. By forming the main shaft 3 in the vertical two-division structure in this manner, the cam 12 and the pinion gear 21 can easily he processed and formed integrally to the main shaft 3 with high accuracy as one member rather than a configuration of a member separate from the main shaft 3. Since the upper side shaft part 30 and the lower side shaft part 31 can be respectively inserted from the upper surface and the lower surface of the body housing 2, the main shaft 3 can easily be assembled.

In the door closer configured as described above, since the main spring is compressed by the cam 12, the door can easily be opened to a fully opened state of for example, 180° by a relatively weak force after the door is opened at a predetermined angle. Since the cam 12 can generate high torque in a door closing direction in the main shaft 3 just before a door is fully closed, the door can surely be closed to a fully closed state. Accordingly, the door closer is particularly suitable for use in, for example, a room with high airtightness and also, is particularly useful for a slide-type door closer.

Since the main shaft 3 is provided with the pinion gear 21 as the buffer driving part for moving the buffer piston 10 separately from the cam 12, the buffer piston 10 can be moved easily greatly without restrictions of the cam 12. Accordingly, at the time of door closing operation, the buffer piston 10 can be moved greatly to run a sufficient amount of working oil into the flow control path 9 and a flow rate of the working oil can easily be adjusted by the adjusting valve 26.

Since the cam 12 and the pinion gear 21 are arranged with the cam 12 vertically displaced from the pinion gear 21, interference between the cam 12 and the pinion gear 21 can easily be prevented and the arrangement is also facilitated. Moreover, coupled with the fact that the upper chamber 4 and the lower chamber 5 are formed with the chambers vertically arranged in parallel, the dimension of the door closet body 1 in the front-back direction can be decreased, with the result that the door closer is particularly suitable for a concealed type arranged inside the door.

Further, since the main spring and the buffer piston 10 are separately arranged in the upper chamber 4 and the lower chamber 5, interference between operation of the main spring and operation of the buffer piston 10 can easily be prevented, and a closing force can be produced accurately according to design of the cam 12 to smoothly run the working oil into the flow control path 9. Since the main spring is arranged in the upper chamber 4, a mechanism for adjusting its spring force is also located in the upper portion of the body housing 2 together with the adjusting valve 26, and both of the spring force and the flow rate of the working oil can easily be adjusted from the upper side and particularly, adjustment work in the concealed type can easily be done.

Since the extension part 5a is formed in the right side of the lower chamber 5, the amount of working oil can be increased by the extension part 5a to reduce deterioration of the working oil. Particularly, since the upper chamber 4 communicates with the lower chamber 5 by the communication hole 7, even when the chambers are arranged vertically independently, the working oil has one large capacity as a whole, and the working oil becomes more stable and braking also becomes more stable than a configuration in which the upper chamber 4 does not communicate with the lower chamber 5 mutually.

Furthermore, air is mixed into working oil in order to absorb expansion of the working oil due to a rise in temperature. Its air accumulates in the upper chamber 4, but the main spring is arranged in its upper chamber 4 and the butter piston 10 is arranged in the lower chamber 5, with the result that the air becomes resistant to entering the flow control path 9, and abnormal noise generated at the time when the air passes through the flow control path 9 can be reduced.

In the present embodiment, the main spring is arranged in the upper chamber 4 and the butler piston 10 is arranged in the lower chamber 5, reverse arrangement may be adopted. That is, as shown in FIG. 5, it may be configured such that a buffer piston 10 is arranged in an upper chamber 4 and also a main spring (a large-diameter coil spring 16 and a small-diameter coil spring 17) is arranged in a lower chamber 5 and a pinion gear 21 is formed in an upper side shaft part 30 and a cam 12 is formed in a lower side shaft part 31. In an aspect shown, in FIG. 5, a lower cap 27 is not formed and accordingly, the upper side shaft part 30 and the lower side shaft part 31 are inserted from an upper surface of a body housing 2. In this aspect, a square shaft part 33 is adopted as joining between the upper side shaft part 30 and the lower side shaft part 31. The right side of the upper chamber 4 is provided with an extension part 4a like the extension part 5a of the lower chamber 5 of FIG. 1. Further, the left side of the lower chamber 5 is provided with an extension part 5a. That is, since the lower chamber 5 is provided with the extension part 5a in the left side opposite to the side in which the main spring is arranged with respect to the cam 12, the upper chamber 4 becomes substantially equal to the lower chamber 5 in transverse length. Since both of the upper chamber 4 and the lower chamber 5 are provided with the extension parts 4a, 5a in this manner, the chambers can be filled with a larger amount of working oil to prevent deterioration of the working oil more effectively. In this case, a flow control path 9 formed so as to upwardly extend from the upper chamber 4 becomes shorter than the case of FIG. 1 since the buffer piston 10 is arranged in the upper chamber 4.

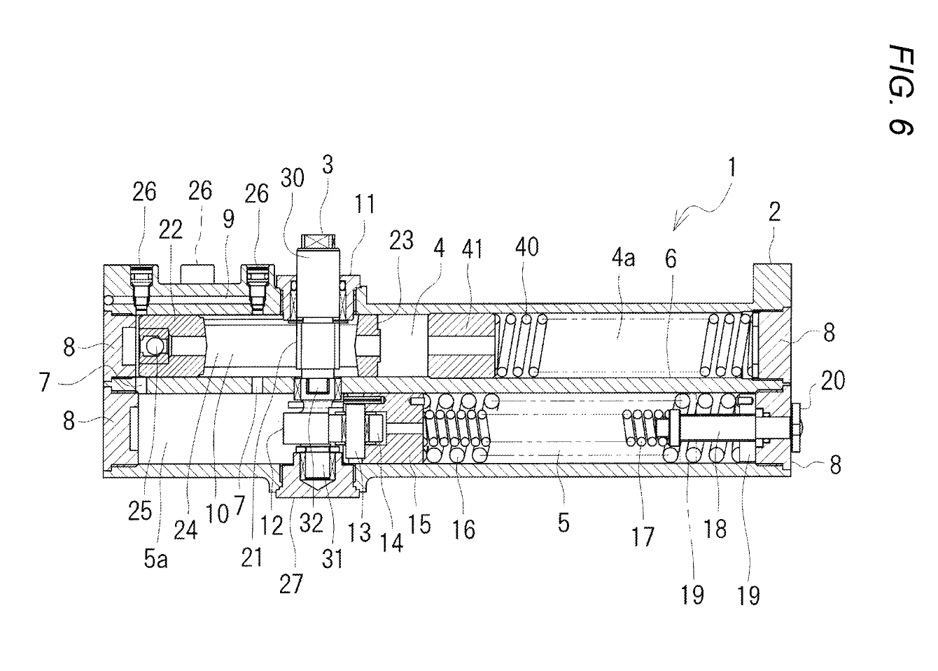

As shown in FIG. 6, the right side of a buffer piston 10 may be provided with an auxiliary spring 40. That is, a spring support 41 is arranged in an extension part 4a of an upper chamber 4, and the auxiliary spring 40 is arranged between the spring support 41 and a right transverse cap 8. The spring support 41 has a larger diameter (larger size) than that of a right head part 23 of the buffer piston 10, and a wall surface of the upper chamber 4 also has a much large diameter by a predetermined length, and the spring support 41 is slidably arranged in the large-diameter portion with the predetermined length. FIG. 6 shows the case of a state in which a door is fully closed, and in the fully closed state, the spring support 41 is pressed by the auxiliary spring 40 and is in the leftmost side, namely, in a position near to the buffer piston 10, but since the spring support 41 abuts on a step part of the wall surface of the upper chamber 4, the spring support 41 cannot be moved to the left side more and does not abut on the buffer piston 10 and is in a position separate from the buffer piston 10 to the right side by a predetermined distance. Then, when the door is opened at a predetermined angle, the buffer piston 10 abuts on the spring support 41, and presses and compresses the auxiliary spring 40 through the spring support 41 at a more opening angle of the door. That is, when the door is opened at a predetermined angle or more, the auxiliary spring 40 starts compressive deformation from an initial state (normal state), and at the time when the door is opened at less than the predetermined angle, the auxiliary spring 40 is not pressed by the buffer piston 10, and is in the initial state and is not compressively deformed. In the initial state, the auxiliary spring 40 may have a natural length, but is preferably compressed by a predetermined amount. An opening angle of the door at the time of starting compression may be set freely, and can be set at an angle of, for example, 100°. Since a configuration using a cam 12 has a weak force necessary to open the door gradually soon after the start of door opening operation, this configuration has an advantage capable of easily opening the door by a weak force, but has a disadvantage of having a weak closing force transmitted from the main spring to the cam 12 at the time when door closing operation is started from a fully opened state. Accordingly, by arranging the auxiliary spring 40 as described above, the auxiliary spring 40 can particularly compensate for the closing force at the time when the door closing operation is started from the fully opened state, and the door closing operation is started surely. Such an auxiliary spring 40 can similarly be applied to the configuration shown in FIG. 1. Since the buffer piston 10 is arranged in the lower chamber 5 in the case of FIG. 1, the extension part 5a of its lower chamber 5 could be provided with the auxiliary spring 40. In any case, the chamber in which the buffer piston 10 is arranged could be provided with the extension part, and the extension part could be provided with the auxiliary spring 40.

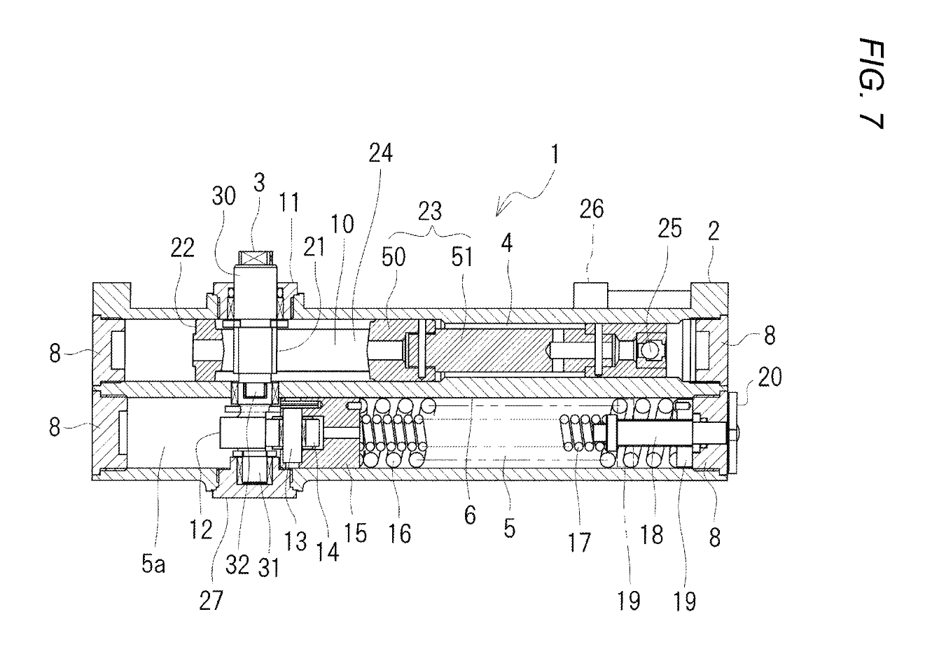

Further, the buffer piston 10 may be arranged, in the direction opposite to that of the above. For example, in FIG. 7, a buffer piston 10 is arranged in an upper chamber 4, and this buffer piston 10 is moved to the left side at the time of door opening operation and is moved to the right side at the time of door closing operation. A check valve 25 is formed in a right head part 23. In an aspect of FIG. 7, the right head part 23 includes a main part 50 and an extended part 51 joined integrally to the right side of the main part 50, and the right end of its extended part 51 is provided with the check valve 25. The right side of a body housing 2 is also provided with a flow control path 9. By arranging the flow control path 9 in the right side, namely, the side remote from the center of rotation of a door in this manner, the dimensions of a door closer body 1 in the left side beyond a main shaft 3, namely, the side near to the center of rotation of the door can be decreased, and the main shaft 3 can approach the center of rotation of the door. Or, the main shaft 3 can be positioned in the center of rotation of the door, and the shaft itself of the center of rotation of the door can also be configured as the main shaft 3. In the aspect of FIG. 7, the left side of a lower chamber 5 is provided with an extension part 5a.

In the embodiment described above, the cam 12 and the pinion gear 21 are respectively processed and formed integrally to the main shaft 3, but the cam 12 or the pinion gear 21 may be assembled to the main shaft 3 as a member separate from the main shaft 3.

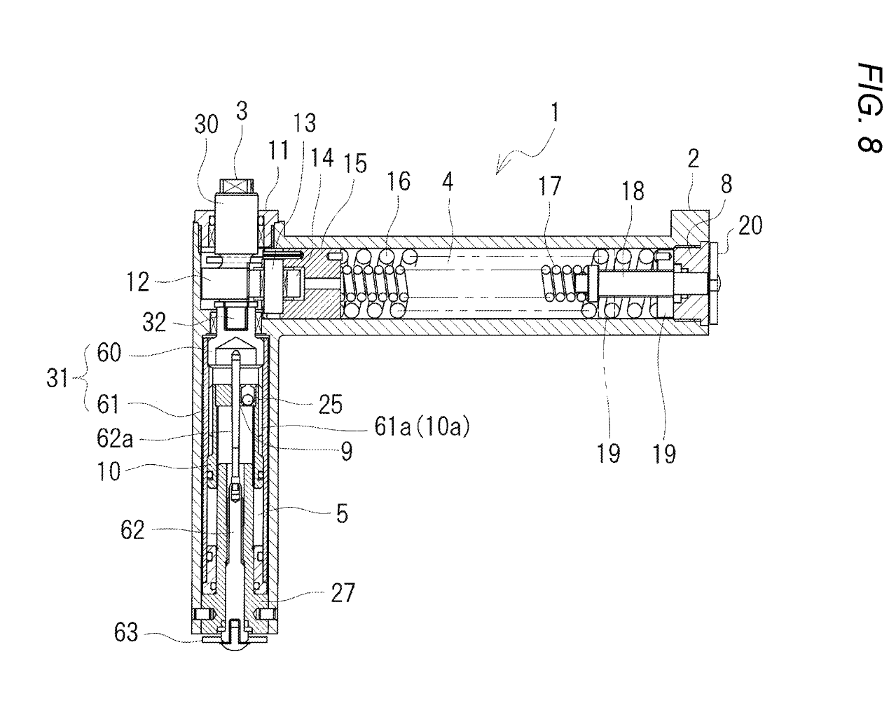

In the embodiment described above, the pinion gear 21 is formed in the main shaft 3 and the buffer piston 10 is formed in the rack 24, but the buffer driving part for moving the buffer piston 10 according to opening and closing operation of the door is not limited to such a rack and pinion mechanism, and various mechanisms can be adopted, and, for example, it may be configured such that a screw part is formed in the buffer piston 10 to be screwed on a screw part of the main shaft 3 and the buffer piston 10 is moved along a shaft fine direction of the main shaft 3 with rotation of the main shaft 3 using this screw feeding mechanism as the buffer driving part. For example, as shown in FIG. 8, a body housing 2 is provided with a landscape upper chamber 4 transversely extending from a main shaft 3 and a portrait lower chamber 5 downwardly extending along the shaft line direction of the main shaft 3, and the body housing 2 is formed in an L shape. An upper part of the main shaft 3 is formed in a cam 12, and a large-diameter coil spring 16 and a small-diameter coil spring 17 as a main spring are arranged in the upper chamber 4 corresponding to a position of the cam 12, and a buffer piston 10 is arranged in the lower chamber 5.

Specifically, a lower side shaft part 31 joined to an upper side shaft part 30 through serrations 32 in the shaft line direction is configured to include a shaft main part 60 having the serrations 32, and a rotating cylindrical body 61 with a cylindrical shape extending downwardly, the upper end of the rotating cylindrical body 61 being fastened to the shaft main part 60. A female screw part 61a is formed on an inner peripheral surface of the rotating cylindrical body 61, and a male screw part 10a in a predetermined region of an upper part of an outer peripheral surface of the buffer piston 10 is screwed on the female screw part 61a, and the main shaft 3, namely, the rotating cylindrical body 61 is rotated to thereby upwardly and downwardly move the buffer piston 10 inside the rotating cylindrical body 61. An upper part of the buffer piston 10 is provided with a cheek valve 25, and the buffer piston 10 is downwardly moved at the time of door opening operation and is upwardly moved at the time of door closing operation and runs working oil into a flow control path 9. An adjusting rod 62 upwardly extends through the center of the upper part of the buffer piston 10. The adjusting rod 62 is independent of the main shaft 3 and accordingly, the adjusting rod 62 is not rotated with rotation of the main shaft 3. The adjusting rod 62 is screwed into a lower cap 27, and the lower end of the adjusting rod 62 is downwardly projected from the body housing 2, and an adjusting gear 63 is fixed to its projected portion. By engaging a tool (not shown) with the adjusting gear 63, the adjusting rod 62 is rotated and the amount of screwing into the lower cap 27 can be changed to upwardly and downwardly move the adjusting rod 62. A predetermined region of the upper side of the adjusting rod 62 has a taper shape with a downwardly gradually smaller diameter, and its taper part 62a is inserted into a through hole of the upper part of the buffer piston 10. A small gap is formed between the adjusting rod 62 and the through hole of the upper part of the buffer piston 10, and the gap is increased when the adjusting rod 62 is upwardly moved, and the gap is decreased when the adjusting rod 62 is downwardly moved. This gap configures the flow control path 9, and the adjusting rod 62 functions as an adjusting valve, and when the buffer piston 10 is upwardly moved at the time of door closing operation, the working oil passes through the gap between the adjusting rod 62 and the through hole of the upper part, and is moved to the downward side. Thus, the body housing 2 is provided with two chambers and the main spring is arranged in one chamber and the buffer piston 10 is arranged is the other chamber and thereby, interference between compression operation of the main spring and movement operation of the buffer piston 10 can easily be prevented.

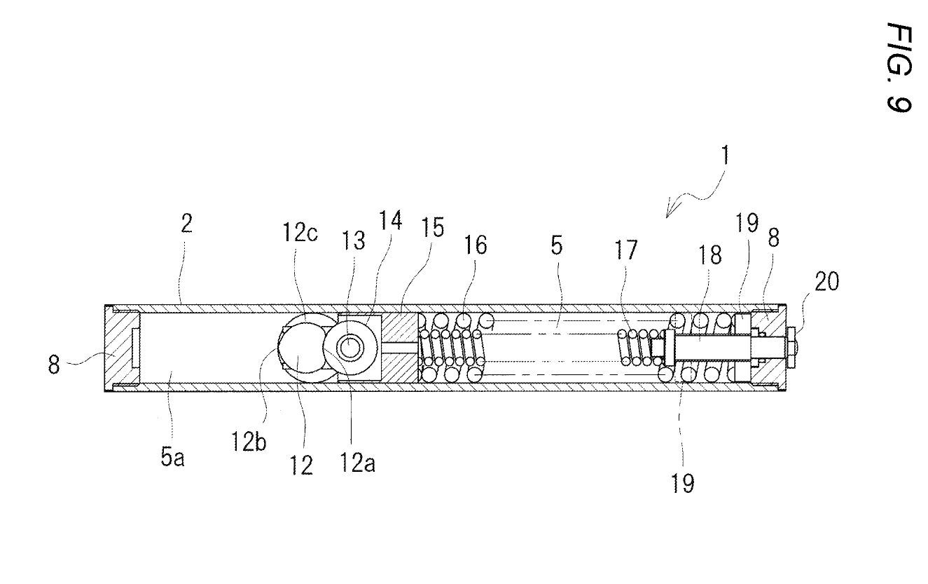

It is unnecessary to form the cam 12 in the asymmetric shape, and the cam 12 may be formed in a symmetric shape hi which the peripheral length of a use section 12c is equal to that of an unused section in opening and closing operation in the whole periphery as shown in FIG. 9. In FIG. 9, a recess 12a, the top 12b and the center of the cam 12 are positioned in a straight line.

In the case of forming a rack 24 in the buffer piston 10, the so-called interior type stopper in which the rack 24 is provided with a stop mechanism for holding a door in a state of a predetermined opening angle may be included.

The case of the door closer of the so-called concealed type in which the door closer body 1 is arranged inside the door is described as art example, but the invention can naturally be applied to a door closer of an external type in which the door closer body 1 is installed on an outer surface of the door.

The main shaft 3 may be used as the turning center of the door depending on the case of arranging the door closer body 1 in the door and fixing the main shaft 3 to the door frame in the state incapable of relative rotation, or the case of arranging the door closer body 1 in the door frame and fixing the main shaft 3 to the door in the state incapable of relative rotation.

### REFERENCE SIGNS LIST

1 Door closer body
2 Body housing
3 Main shall
4 tipper chamber
4a Extension part
5 Lower chamber
5a Extension part
6 Partition wall
7 Communication hole
8 Transverse cap
9 Flow control path
10 Buffer piston
10a Male screw part
11 Upper cap
12 Cam
12a Recess
12b Top
12c Use section
13 Support shaft
14 Roller
15 Spring support
16 Large-diameter: coil spring (Main spring)
17 Small-diameter coil spring (Main spring)
18 Adjusting shaft
19 Spring force adjusting nut
20 Adjusting gear
21 Pinion gear (Buffer driving part)
22 Head part
23 Head part
24 Rack
25 Check valve
26 Adjusting valve
27 Lower cap
30 Upper side shaft part
31 Lower side shaft part
32 Serration
33 Square shaft part
40 Auxiliary spring
41 Spring support
50 Main part
51 Extended part
60 Shaft main part
61 Rotating cylindrical body
61a Female screw part (Buffer driving part)
62 Adjusting rod
62a taper part
63 Adjusting gear

1. A door closer comprising:
a main shaft rotated with opening and closing operation of a door;
a main spring for producing a closing force; and
a buffer piston for running working oil into a flow control path in order to buffer a door closing operation,
wherein the main shaft is provided with:
a cam for elastically deforming the main spring at the time of door opening operation and being subjected to the closing force of the main spring at the time of the door closing operation; and
a buffer driving part for moving the buffer piston according to opening and closing operation of the door, the buffer driving part being provided to the main shaft separately from the cam:,
wherein a body housing comprises two chambers, one of which is provided with a main spring and the other of which is provided with a buffer piston,
wherein a shaft line direction of the main shaft is a vertical direction, and the door closer is provided with a buffer driving part displaced from the cam in the vertical direction,
wherein the body housing comprises an upper chamber and a lower chamber having working oil therein, the main spring is arranged in one of the upper chamber and the lower chamber, and the buffer piston is arranged in the other of the upper chamber and the lower chamber.
wherein the door closer further comprises a pinion gear as the buffer driving part,
wherein a rack configured to helically engage the pinion gear is formed in the buffer piston,
wherein an elastic deformation direction of the main spring is mutually parallel to a movement direction of the buffer piston,
wherein the upper chamber and the lower chamber are arranged adjacently in the vertical direction, and
wherein at least one of the upper chamber and the lower chamber comprises an extension part in at least one of: a side opposite to a side in which the main spring is arranged with respect to the cam; and a further door opening side that is further beyond a position that is a maximum moving position of the buffer piston at the door opening side.

2. The door closer according to claim 1, wherein the door closer is a slide-type door closer configured such that a distal end of an arm, which is rotated integrally with the main shaft, is guided by a rail and is slid.

3-5. (canceled)

6. The door closer according to claim 1,
wherein the extension part of the at least one of the upper chamber and the lower chamber is formed in the further door opening side that is further beyond the position that is the maximum moving position of the buffer piston at the door opening side, and
wherein the extension part is provided with an auxiliary spring that is not elastically deformed at the time when the door is opened at less than a predetermined angle and is elastically deformed at the time when the door is opened at the predetermined angle or more.

7. The door closer according to claim 1,
wherein the main shaft has a divided structure in the vertical direction,
whrein the cam is formed integrally to one of an upper side shaft part and a lower side shaft part, both of which configures the main shaft, and the pinion gear as the buffer driving part is formed integrally to the other of the upper side shaft part and the lower side shaft part, and
wherein the rack configured to helically engage the pinion gear is formed in the buffer piston.
